(19) United States
(12) Patent Application Publication
(10) Pub. No.: US 2015/0125230 A1
(43) Pub. Date: May 7, 2015

(54) APPARATUS FOR AN ON-TOOL POWER SUPPLY

(71) Applicant: LOCKHEED MARTIN CORPORATION, Bethesda, MD (US)

(72) Inventor: Jan De Nijs, Gotha, FL (US)

(73) Assignee: LOCKHEED MARTIN CORPORATION, Bethesda, MD (US)

(21) Appl. No.: 14/069,414

(22) Filed: Nov. 1, 2013

(51) Int. Cl. B23Q 1/00; B23Q 11/10; B23Q 17/24; F01B 23/10

(52) U.S. Cl. CPC B23Q 1/0009; F01B 23/10; B23Q 11/1023; B23Q 17/24
USPC 409/136; 409/183; 409/203; 483/30

(57) ABSTRACT

An apparatus comprises a housing and a tool holder that is mounted to a first end of the housing. The tool holder is configured for selectively engagement with a spindle to support the tool and selective disengagement from the spindle for interchanging the tool with other tools. The tool further comprises a work-piece end mounted to a second end of the housing to perform component forming functions and/or component inspection functions. At least one energy harvesting device at the housing is configured to harvest a form of energy associated with the operation of the apparatus to generate sufficient electrical power for wholly powering the machine implement. Accordingly, there is an electrical interconnection between the at least one energy harvesting device and the work-piece end.

### BACKGROUND

Embodiments relate to machines and apparatuses that have a spindle arm to which machine tools are interchangeably attached. More specifically, embodiments relate to milling machines that include spindle arms that are controlled to move between a first position at which a work-piece is milled or inspected and a second position at which tools are interchanged on the spindle.

Milling machines are used to quickly remove metal from blanks or work-pieces. Typically, the milling machines include a spindle, on which tools are mounted for cutting, machining or otherwise forming the work-piece into a component. The tools are operatively connected to rotating elements of the spindle so the tool, which has cutting teeth or edges, is rotated for removing material from the work-piece and forming the component by rotating the tool on the spindle.

A tool storage device, known as a magazine, has multiple cutting tools for performing multiple different milling or machining operations. Each cutting tool typically has a tapered holder that mates with a receiving end of the spindle to secure the tool to the end of the spindle. The spindle is controlled to move between positions at which a tool is used to function and remove material from the work-piece and positions at which the tool is removed from the spindle and another tool is secured to the spindle. This automated tool interchange significantly increases the flexibility and efficiency of the milling machine.

In recent years, due to miniaturization of electrical and sensor components, it has become possible to build compact accurate sensor devices that can be attached to the tool holders of milling machines. These devices require power, and some require a significant amount of power; however, transmitting a larger amount of power to these devices is a challenge, because it requires the inclusion of a sizeable battery or battery pack. Relatively large batteries almost always pose weight challenges. Another method of feeding power to these devices is to use an external power cable; however, power cables limit the usability of the tools since the cable (sometimes called an “umbilical cord”) prevents automatic tool changes and hinders automatic machining operations. More specifically, the cable will be “ripped” out of the device, if it is not first disconnected. To that end, connecting and disconnecting the power cable adds processing steps to the milling operations increasing the amount of time necessary to machine a component.

### SUMMARY

Embodiments relate to an apparatus that comprises a spindle that is configured to receive and support different tools. The spindle is moveable between one or more first positions for forming or inspecting a work-piece and one or more second positions at which tools are interchanged on and off the spindle. The apparatus also comprises a tool having a tool holder that is detachably secured to an end of the spindle for the interchange of tools on and off the spindle. The tool also has a work-piece end distal to the tool holder. An energy harvesting device is provided on the tool and is in electrical communication with the work-piece end and the energy harvesting device is configured to harvest a form of energy generated from the operation of the apparatus to generate sufficient electrical power for wholly powering the work-piece end.

The work-piece end may comprise a sensor for inspecting features of the work-piece that have been formed and/or a laser marking tool and/or tools that perform automated steps in the manufacture of the work-piece into a component. Non-limiting examples of such tools may include a dowel pin inserter, rivet installer, automatic threaded inserter or a puncher. In non-limiting examples, power may be harvested from compressed air injected through the spindle, a coolant fluid injected through the spindle or rotation of components of the spindle. Embodiments resolve the above-described power supply problem by using the power sources available at the spindle, to locally generate significant power. At the same time, the tool can be automatically interchanged, maintaining flexibility and efficiency.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 illustrates a side view of an apparatus with a tool mounted on a spindle in accordance with embodiments.

FIG. 2 illustrates the components of the tool and a sectional view of the spindle.

FIG. 3 illustrates an exploded view of the tool shown in FIG. 1.

FIG. 4 illustrates a schematic representation of an embodiment with an energy harvesting device that harvests rotational movement of the spindle.

FIG. 5 illustrates a schematic representation of the embodiment of FIG. 4 wherein the energy harvesting device powers a laser marking tool.

FIG. 6 illustrates a schematic representation of the embodiment of FIG. 4 wherein the energy harvesting device powers a tool for the automated insertion of threaded inserts.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

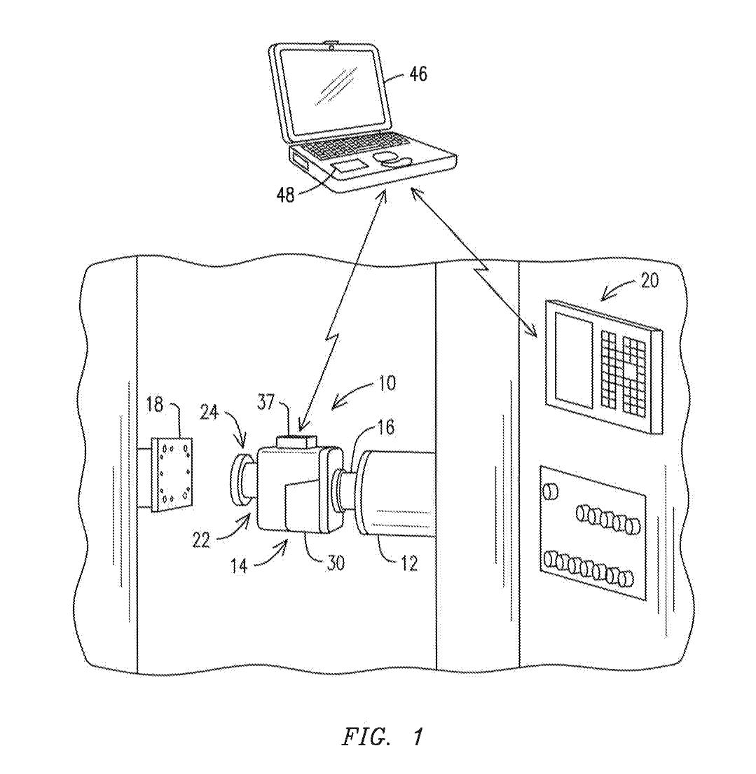

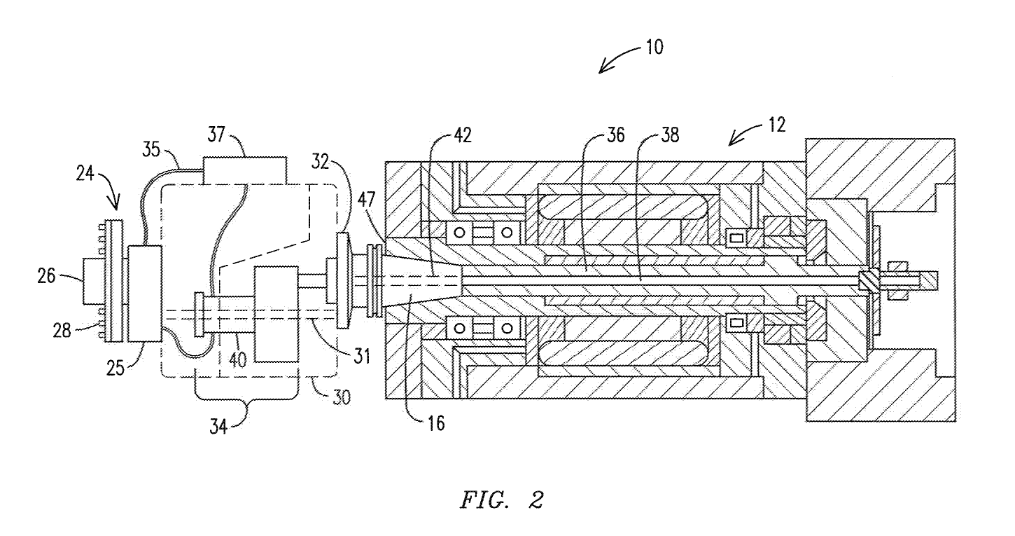

With respect to FIGS. 1 and 2, an embodiment is shown and is an apparatus 10 comprising a spindle 12 and a tool 14 including a tool holder 16 secured in mating relationship with an end of the spindle 12. In a non-limiting example, the spindle 12 may be a component of a milling machine for cutting and machining, or performing other fabricating steps, to form a component from a work-piece 18. Accordingly, the spindle 12 may be operatively linked to mechanical drive systems and control systems 20 to move the spindle 12, including rotating elements of the spindle 12, to machine a work-piece 18 with cutting tools or to move the spindle 12 to interchange tools on and off the spindle 12. The above-described operation of a machining tool with a spindle 12 is well known to those skilled in the art.

As shown, the tool 14 has a work-piece end 22 that faces the work-piece 18 and is distal to the tool holder 16. In this illustrative embodiment, the work-piece end 22 comprises a sensor 24 that may be used to inspect to the work-piece 18 as part of a machining process. In a non-limiting example, the sensor 24 may be an imaging device or visual metrology sensor. Accordingly, the sensor 24 may include a camera 25 and lens 26 and a lighting element 28 (including a plurality of LEDs) mounted to a housing 30. The camera 25 may include discreet output lines that can be programmed to create different lighting patterns, depending in part on the feature of the work-piece 18 being inspected.

The tool holder 16 is mounted on a housing 30 opposite the sensor 24. More specifically, the tool holder 16 has a mounting flange 32 for attachment of the tool holder 16 to the housing 30. As shown in FIGS. 1-3, tool holder 16 may have a generally conical shape that is positioned in mating relationship with the spindle nose 32. The attachment and detachment of the tool holder 16 relative to the spindle 12 is a routine operation that is well known to those skilled in the art.

The sensor 24 is in electrical communication with a wireless transceiver 37 via a communication line 35 such as an Ethernet cable, and the sensor 24 transmits signals indicative a condition being monitored by the sensor 24. In the non-limiting example of an imaging device, the sensor 24 sends data representing images of features of the work-piece 18 formed during manufacturing. The transceiver 37 transmits the data to a computer 46 that also includes a transceiver 48 for wireless communication between the sensor 24 and computer 46.

The computer 46 may include software programming with executable instructions to perform one or more inspection routines and/or tasks. More specifically, the software programming may be configured to determine if the tool 14 and sensor 22 are in position to perform an inspection routine and/or task. Once the tool 14 is determined to be in position, the computer 46 transmits signals to the transceiver 37 to activate the sensor 14 to generate work-piece inspection data such as images of features of the work-piece 18 according to a predetermined inspection routine. To that end, the computer 46 communicates with the control system 20 for transmission of signals indicative of the status of the inspection routine and/or tasks. Accordingly, the computer 46 transmits a signal to the control system 20 indicating an inspection routine and/or task has been completed. The control system 20 is equipped with programmed executable instructions according to a predetermined machining operation to form a component from the work-piece 18. The machining operation includes work-piece inspection routines and/or tasks, so the control system 20 is configured to control the operation of the spindle 12 to interchange a cutting tool (not shown) with the tool 14 for inspection of the work-piece 18. The control system 20 also generates signals to the computer 46 indicating the tool 14 is in position for inspection.

An energy harvesting device 34 is mounted within the housing 30 and generates power from operating conditions associated with the operation of the apparatus 10 and/or spindle 12. In a non-limiting example, the harvesting device 34 may harvest energy from fluid flow through the spindle and tool holder 16. As shown in FIG. 3, the spindle 12 has a hollow shaft 36 forming a first fluid flow passage 38 through the spindle 12 to the spindle nose 47 to which a tool is attached. During milling or cutting operations, compressed air is injected through the fluid flow passage 38 to the spindle nose 47. Tool holders for cutting tools such as drill bits typically have fluid flow passages through the tool holder and bit so that air is delivered through the nose of the tool to clear the work-piece 18 of material removed by the tool. In addition, coolant fluid may also be delivered through the spindle 12 and cutting tool to control and maintain the operating temperatures of the tool and work-piece 18 during milling or cutting operations. Accordingly, a second fluid flow passage 42 extends through the tool holder 16 for delivery of fluid flow to the energy harvesting device 34.

In an embodiment, the energy harvesting device 34 may comprises a turbine generator 40 in fluid flow communication with the first and second fluid flow passages 38, 42. The turbine generator 40 is supported in the housing 30 by support members 31. Accordingly, when fluid is delivered to the tool, the turbine generator 40 generates power or electricity that is delivered to the sensor 24. The turbine generator 40 may also be in electrical communication with the transceiver 37 and lighting element 28 (including any control circuits that control the lighting) to power all components of the tool 14.

During prototype testing a 150W Tesla turbine was used to power a programmable National Instruments 1776C camera and lens and a Blue Tooth transceiver (Phoenix Contact PN 2693091). Such a turbine generator operating at 14,000 rpm can produce about 10V of power. It was determined that with the delivery of about 7 to 8 cubic feet per minute of compressed air the turbine generator has an electrical output of 60 watts, which was enough to power the camera and the transceiver. By the time compressed air reaches the spindle nose 47 the air is under pressure at about 60 psi; however, a coolant may be delivered to the spindle nose 47 at 1000 psi providing capacity to generate more power. In such an embodiment the tool 14 may need to be configured to exhaust some coolant so as not to overload the turbine generator 40. To that end, the turbine generator 40 may include a power bleed off circuit including a resistor circuit to bleed off power on occasions the turbine generator 40 produces too much power.

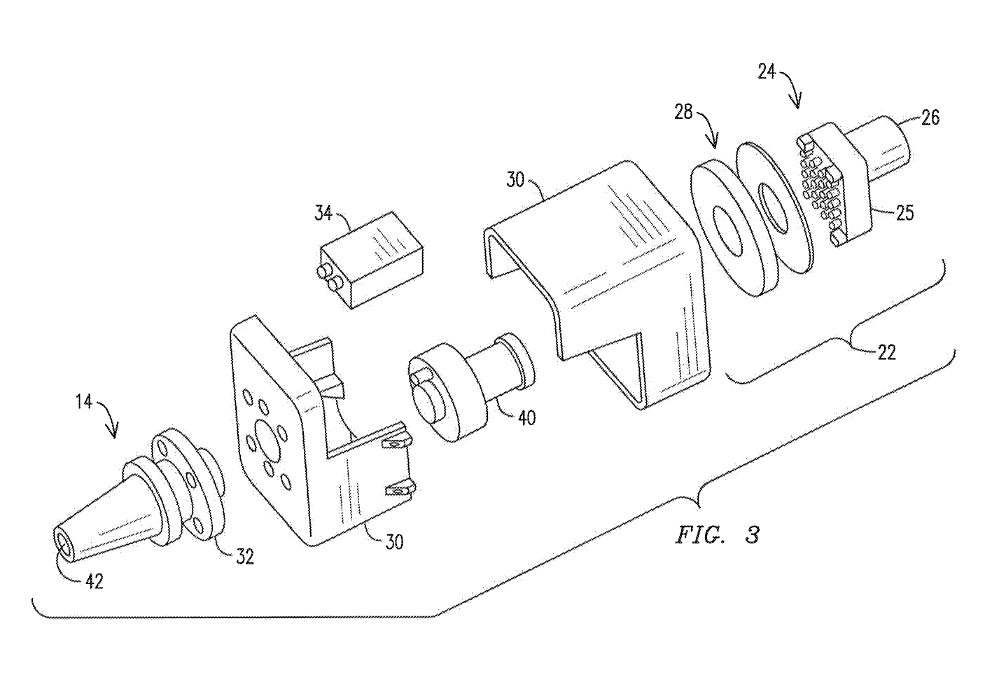

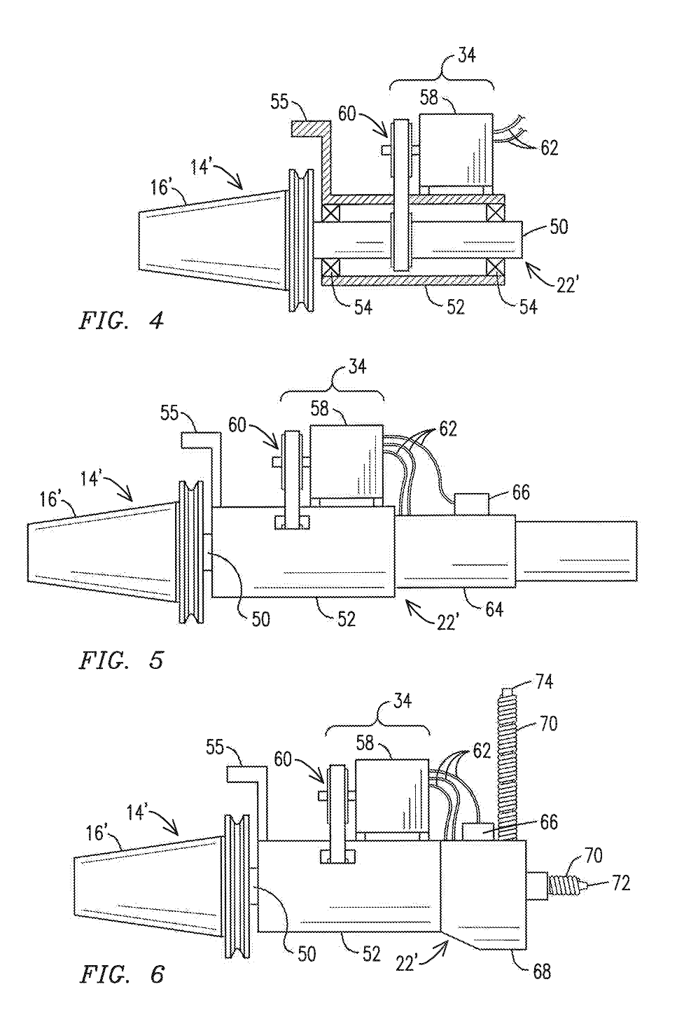

With respect to the embodiments illustrated in FIGS. 4-6, the energy harvesting device 34′ harvests energy from the rotational motion of the spindle 12 transmitted to a shaft 50 of the tool 14′ and tool holder 16′. As shown, the tool includes a housing 52 with a stop 55 for attachment to a stationary part of the spindle 12 (not shown). Bearings 54 are disposed between the shaft 50 and the housing 52 so that the housing 52 remains stationary as the tool holder 16′ and shaft 50 rotate. Similar configuration, including a stationary housing and stop feature, may be found on milling tools that include right angle heads that are well known to those skilled in the art.

As shown, a generator 58 is mounted to the housing 52. The generator 58 is operatively connected to the rotating shaft 50 via a belt and pulley mechanism 60. Thus, when the shaft 50 rotates the generator 58 outputs power or electricity via electrical lines 62 to a work-piece end including a sensor or tool as described above. In the embodiment shown in FIG. 5, the work-piece end 18′ includes a laser marker 64 and a transceiver 66. The electrical lines 62 deliver electricity to the laser marker 64 to power the device and mark a work-piece or component as desired. As described above, the transceiver 66 may receive signals from the computer 46 or control system 20 wherein the signals may indicate steps in a marking routine or procedure. In addition, in a non-limiting example the transceiver 66 and/or one or more control circuits of the laser marker 64 may transmit signals indicative of the status of a laser marking step and/or the position of the laser marker 64.

In the embodiment shown in FIG. 6, the work-piece end 18′ includes device 68 for inserting threaded inserts 70 into a work-piece or a component. The device 68 may include a probe 72 on which a threaded insert 70 is positioned for insertion into a component or work-piece. The probe 72 and device 68 are configured and operatively connected to the shaft 50 so that the probe 72 rotates and moves toward and away from a work-piece for rotating insertion of the threaded insert. As shown, the device 68 may include a holder 74 for supporting multiple threaded inserts 70 to perform a plurality of operations during machining or component forming operations. Accordingly, the device 68 is equipped with moving parts and control circuitry to move a threaded insert 70 from the holder 74 to the probe 72. As further shown, the tool 14′ includes a transceiver 66 that receives signals from the computer 46 or control system 20 to perform steps for inserting the threaded inserts, and transmits signals indicative of the status of each step.

The above-described embodiment including an apparatus and/or tool with an energy harvesting device to power the tool to perform routines or steps of a component forming operation solves the above-describe problems associated with prior art devices. While the embodiments described relative FIGS. 1-6 include a sensor 24, laser marker 64 and inserter device 68, the embodiment is not so limited and covers other tools such as dowel inserters, rivet installers and punchers. In addition, embodiments are not limited to the particular energy harvesting devices described herein. In a non-limiting example, the generator 58 in FIGS. 4-6 may take the form of magnets mounted to the shaft 50 and electrical coils mounted to an internal surface of the housing 52, whereby the rotation of the shaft 50 and magnets generates electricity that is transmitted to the work-piece end of the tool 14′. In addition, other operating conditions such as temperature (heat) or vibration may be harvested wherein the energy harvesting device may include a thermoelectric harvesting device, a thermo-voltaic harvesting device, a piezoelectric harvesting device or combination of these devices.

While embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered. Moreover, unless specifically stated, any use of the terms first, second, etc., does not denote any order or importance, but rather the terms first, second, etc., are used to distinguish one element from another.

What is claimed is:

1. An apparatus comprising:
a spindle that is configured to receive and support different tools and is moveable between one or more first positions for forming or inspecting a work-piece and one or more second positions at which tools are interchanged on and off the spindle;
a tool having a tool holder that is detachably secured to an end of the spindle for the interchange of tools on and off the spindle and the tool having a work-piece end distal to the tool holder; and,
an energy harvesting device on the tool and in electrical communication with the work-piece end and the energy harvesting device is configured to harvest a form of energy generated from the operation of the apparatus to generate sufficient electrical power for wholly powering the work-piece end.

2. The apparatus of claim 1, wherein the spindle has a fluid flow passageway through which fluid passes during operation of the apparatus and the energy harvesting device is a turbine generator, and the turbine generator is in fluid flow communication with the spindle fluid flow passageway.

3. The apparatus of claim 1, wherein the tool has a shaft that is operatively connected to the spindle and the shaft rotates and the energy harvesting device is a generator operatively connected to the rotating shaft.

4. The apparatus of claim 1, wherein the work-piece end comprises a sensor that generates one or more data signals indicative of a feature of the component being formed by the apparatus.

5. The apparatus of claim 4, further comprising a transceiver that is configured to receive the one or more data signals from the sensor and is configured to transmit data indicative of the component feature inspected.

6. The apparatus of claim 6, wherein the sensor is a visual metrology sensor.

7. The apparatus of claim 5, wherein the transceiver is further configured to receive the transmission of one or more signals indicative to steps to perform in a work-piece inspection routines.

8. The apparatus of claim 1, wherein the work-piece end is a laser marking device.

9. An apparatus comprising:
a spindle that is configured to receive and support multiple tools and is moveable between one or more first positions for shaping or inspecting a work-piece and one or more second positions at which tools are interchanged on and off the arm;
a first tool having a tool holder configured for detachably securing the first tool to the spindle and having a work-piece end;
an energy harvesting device on the first tool and in electrical communication with the work-piece end and the energy harvesting device is configured to harvest a form of energy generated from the operation of the apparatus to generate sufficient electrical power for wholly powering the work-piece end;
a second tool having a tool holder configured for detachably securing the first tool to the spindle and having a work-piece end distal the tool holder and the work-piece end is actuated by rotation of the spindle and tool holder; and,
a controller configured to perform executable programmable instructions to select either the first tool or the second tool for attachment to the spindle, to control movement of the spindle to position spindle for attachment of the selected first or second tool to the spindle and to control movement of the spindle to position the selected first or second tool relative to the work-piece for forming or inspecting the work-piece.

10. The apparatus of claim 9, wherein the work-piece end of the first tool comprises a sensor that transmits one or more data signals indicative of one or more features formed on the work-piece.

11. The apparatus of claim 9, further comprising a wireless transceiver powered by the energy harvesting device and the transceiver is configured for receiving signals indicative of component forming or inspection tasks and for transmitting one or more signals indicative of the status of the component forming or inspection tasks.

12. The apparatus of claim 10, wherein the sensor comprises one or more visual metrology sensors.

13. The apparatus of claim 9, wherein the work-piece end of the first tool comprises a laser marking device.

14. The apparatus of claim 9, wherein the work-piece end of the first tool comprises work-piece forming tool or part insertion tool.

15. The apparatus of claim 10, wherein controller accesses data relative to a plurality of inspection tasks to be performed according to a predetermined sequence and the controller controls the sensor to perform each inspection task according to the predetermined sequence.

16. The apparatus of claim 10, further comprising a wireless transceiver operatively connected to the sensor and is configured to receive the one or more signals from the sensor and is configured to transmit data relating to the inspected feature of the work-piece.

17. An apparatus comprising:
a housing;
a tool holder mounted to a first end of the housing and the tool holder is configured for selectively engagement with a spindle to support the tool and selective disengagement from the spindle for interchanging the tool with other tools;
a work-piece end mounted to a second end of the housing to perform component forming functions and/or component inspection functions;
at least one energy harvesting device at the housing and configured to harvest a form of energy associated with the operation of the apparatus to generate sufficient electrical power for wholly powering the machine implement; and,
an electrical interconnection between the at least one energy harvesting device and the work-piece end.

18. The apparatus of claim 17, wherein the energy-harvesting device is selected from the group consisting of a thermoelectric harvesting device, a thermo-voltaic harvesting device, a piezoelectric harvesting device, and a combination of the foregoing devices.

19. The apparatus of claim 17, wherein energy harvesting device comprises a turbine generator in fluid communication with a source of pressurized fluid.

20. The apparatus of claim 17, wherein the work-piece end comprises a sensor.

21. The apparatus of claim 20, wherein the sensor is an imaging device.

22. The apparatus of claim 20, further comprising a transceiver in signal communication with the sensor and powered by the energy harvesting device, and the transceiver is configured for wireless transmission of data received from the sensor.

23. The apparatus of claim 17, wherein the work-piece end comprises a laser marking device.
